(19) United States
(12) Patent Application Publication
(10) Pub. No.: US 2026/0003607 A1
(43) Pub. Date: Jan. 1, 2026

(54) REAL-TIME, REBOOT-LESS CONFIGURATION OF ENTERPRISE NETWORK INTERFACE CARDS

(71) Applicant: Dell Products L.P., Round Rock, TX (US)

(72) Inventors: Pavan Kumar Gavvala, Bangalore (IN); Anshul Simlote, Bengaluru (IN); Madhu Krishna Goduguloori, Bengaluru (IN); Murali Mani, Bengaluru (IN)

(21) Appl. No.: 18/755,807

(22) Filed: Jun. 27, 2024

(51) Int. Cl. G06F 8/656

(52) U.S. Cl. CPC G06F 8/656

(57) ABSTRACT

A method for real-time, reboot-less configuration of network interface cards. The method includes: constructing a network interface binary large object (NI-BLOB) including a firmware update package; transferring, to a network interface card, a firmware update including the NI-BLOB; and activating, without power-cycling a host whereon the network interface card is installed, the firmware update to configure the network interface card in real-time. In foregoing the power-cycling of the host, embodiments described herein minimize (if not eliminate) any service downtime potentially caused through the frequent application of configuration changes to network interface card(s).

### BACKGROUND

In order to effect configuration changes on any enterprise network interface card(s), existing solutions lack any ability to apply said configuration changes during runtime (or in real-time), thereby requiring the power-cycling of any respective host system(s).

### SUMMARY

In general, in one aspect, embodiments described herein relate to a method for real-time, reboot-less configuration of network interface cards. The method includes: constructing a network interface binary large object (NI-BLOB) including a firmware update package; transferring, to a network interface card, a firmware update including the NI-BLOB; and activating, without power-cycling a host whereon the network interface card is installed, the firmware update to configure the network interface card in real-time.

In general, in one aspect, embodiments described herein relate to a non-transitory computer readable medium (CRM). The non-transitory CRM includes computer readable program code, which when executed by a computer processor, enables the computer processor to perform a method for real-time, reboot-less configuration of network interface cards. The method includes: constructing a network interface binary large object (NI-BLOB) including a firmware update package; transferring, to a network interface card, a firmware update including the NI-BLOB; and activating, without power-cycling a host whereon the network interface card is installed, the firmware update to configure the network interface card in real-time.

In general, in one aspect, embodiments described herein relate to a system. The system includes: a set of network interface cards including a network interface card; and a remote access controller operatively connected to the set of network interface cards, and including a computer processor configured to perform a method for real-time, reboot-less configuration of network interface cards. The method includes: constructing a network interface binary large object (NI-BLOB) including a firmware update package; transferring, to the network interface card, a firmware update including the NI-BLOB; and activating, without power-cycling a host whereon the network interface card is installed, the firmware update to configure the network interface card in real-time.

Other aspects of the embodiments described herein will be apparent from the following description and the appended claims.

### BRIEF DESCRIPTION OF DRAWINGS

Certain embodiments described herein will be described with reference to the accompanying drawings. However, the accompanying drawings illustrate only certain aspects or implementations of the embodiments by way of example and are not meant to limit the scope of the claims.

FIG. 1 shows a system in accordance with one or more embodiments described herein.

FIG. 2 shows a network interface binary large object in accordance with one or more embodiments described herein.

FIG. 3 shows a flowchart outlining a method for real-time, reboot-less configuration of enterprise network interface cards in accordance with one or more embodiments described herein.

FIG. 4 shows a computing system in accordance with one or more embodiments described herein.

### DETAILED DESCRIPTION

Specific embodiments will now be described with reference to the accompanying figures.

In the below description, numerous details are set forth as examples of embodiments described herein. It will be understood by those skilled in the art (who also have the benefit of this Detailed Description) that one or more embodiments of embodiments described herein may be practiced without these specific details, and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

In general, embodiments described herein relate to the real-time, reboot-less configuration of enterprise network interface cards. Particularly, in order to effect configuration changes on any enterprise network interface card(s), existing solutions lack any ability to apply said configuration changes during runtime (or in real-time), thereby requiring the power-cycling of any respective host system(s). When considering certain operations, such as in telecommunications and in cloud information technology (IT) infrastructures, where configuration changes are often frequent, said power-cycling requirement leads to extensive, unwanted service downtime.

Serving to address the above-mentioned faults and/or limitations, embodiments described herein propose a mechanism through which the real-time, reboot-less configuration of enterprise network interface cards is possible. Said mechanism, more specifically, generates a binary large object (BLOB)—including configuration changes in the form of virtual address management (VAM) commands—that can be transferred to, and subsequently activated on, any enterprise network interface card(s). Said mechanism, further, implements a self-contained activation method of the configuration changes, where said method enables any enterprise network interface card(s) to: autonomously initiate an auto-reboot upon receipt of an activation command; transition to a bootloader mode; and, subsequently, start up with the configuration changes applied. As a result, embodiments described herein forego power-cycling of any host system(s), thereby minimizing (if not eliminating) any service downtime potentially caused through the frequent application of configuration changes to any enterprise network interface card(s).

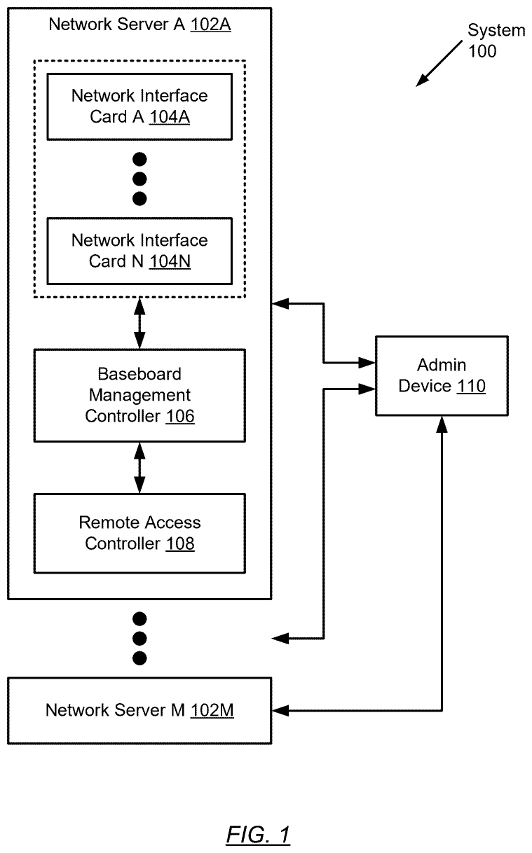

FIG. 1 shows a system in accordance with one or more embodiments described herein. The system (100) may include one or more network servers (102A-102M) operatively connected to an admin device (110). Each of these system (100) components is described below.

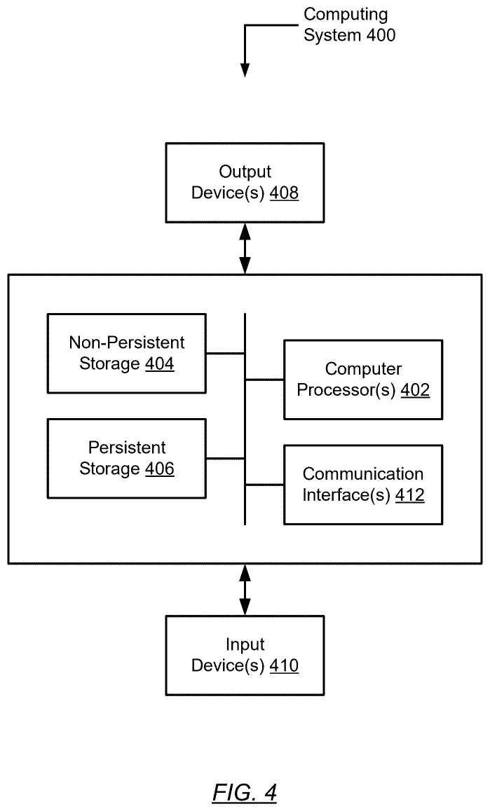

In one or many embodiment(s) described herein, any network server (102A-102M) may represent a physical appliance (e.g., the exemplary computing system illustrated and described below with respect to FIG. 4) at least configured to receive, generate, process, store, and/or transmit data, as well as provide an environment in which one or many workload(s) may be performed thereon or there-through. Any said workload may refer, but is not limited, to a service offered locally and/or over a network (not shown), a computational task/function, or a data transaction. Further, in providing said execution environment for any workload(s) being performed thereon or there-through, any network server (102A-102M) may include or have access to, and thus allocate and de-allocate, various resources (e.g., computer processors, memory, storage, virtualization, network bandwidth, etc.), as needed, to said workload(s). One of ordinary skill, however, will appreciate that any network server (102A-102M) may perform other functionalities without departing from the scope of the embodiments described herein.

In one or many embodiment(s) described herein, any network server (102A-102M) may include one or more network interface cards (NICs) (104A-104N), a baseboard management controller (BMC) (106), and a remote access controller (RAC) (108). Each of these network server (102A-102M) subcomponents is described below.

In one or many embodiment(s) described herein, any NIC (104A-104N) (also referred to as a network adapter or a physical network interface) may refer to any number of integrated circuits collectively configured for facilitating the connection of a host system (e.g., a network server (102A-102M)) to one or more networks (not shown). To that extent, and at least in part, any NIC (104A-104N) may include functionality to transmit and receive network communication (e.g., network packets or frames) through any number of wired and/or wireless network communication mediums and protocols. One of ordinary skill, however, will appreciate that any NIC (104A-104N) may perform other functionalities without departing from the scope of the embodiments described herein.

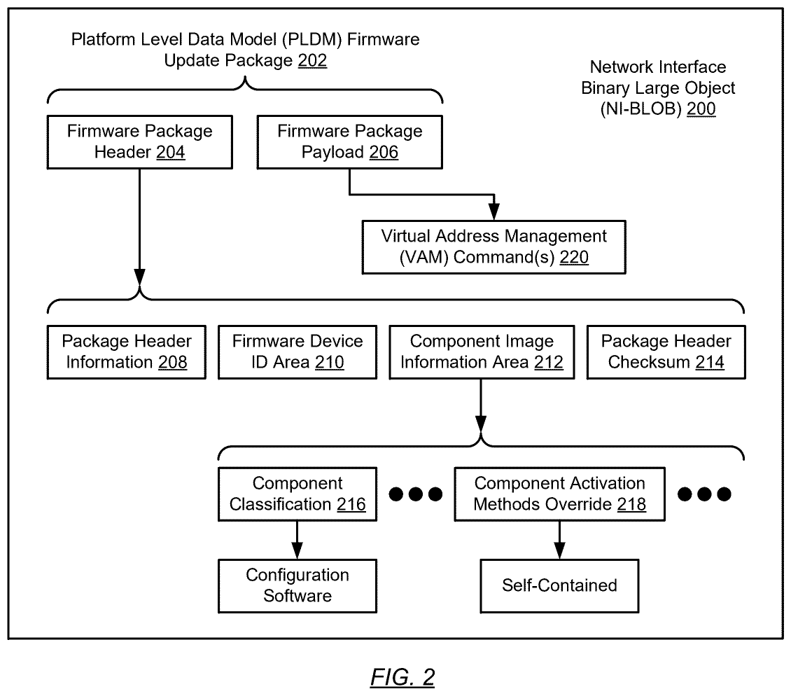

For example, in one or many embodiment(s) described herein, any NIC (104A-104N) may include further functionality to: receive any number of firmware updates via the BMC (106) yet originating from the RAC (108), where each of said firmware updates includes a network interface binary large object (NI-BLOB) (see e.g., FIG. 2) reflecting one or more virtual address management (VAM) commands directed to enabling a real-time, reboot-less configuration of the NIC (104A-104N); and apply said received firmware update(s), in a self-contained manner, upon receiving an update activation command again from the RAC (108) via the BMC (106).

In one or many embodiment(s) described herein, the BMC (106) may refer to any number of integrated circuits collectively configured for out-of-band management of the host system (e.g., a network server (102A-102M)). To that extent, and at least in part, the BMC (106) may include functionality to: monitor host system health through any number of hardware sensors; access host system logs; and perform power management tasks. One of ordinary skill, however, will appreciate that the BMC (106) may perform other functionalities without departing from the scope of the embodiments described herein.

For example, in one or many embodiment(s) described herein, the BMC (106) may include further functionality to: interface with any number of other hardware or physical components of the host system, including any NIC(s) (104A-104N); and mediate any communication(s) and/or information transfer(s) (e.g., firmware updates) between any NIC(s) (104A-104N) and the RAC (108).

In one or many embodiment(s) described herein, the RAC (108) may refer to any number of integrated circuits collectively configured for advanced out-of-band management of the host system (e.g., a network server (102A-102M)). To that extent, and at least in part, the RAC (108) may include functionality to: provide virtual media support and remote console access; monitor and control thermal radiation dynamics; enable automatic security certificate renewal and enrollment; facilitate remote firmware updates; execute agent-free monitoring of the host system; and offer scalable data analytics at least concerning host system operations and events. One of ordinary skill, however, will appreciate that the RAC (108) may perform other functionalities without departing from the scope of the embodiments described herein.

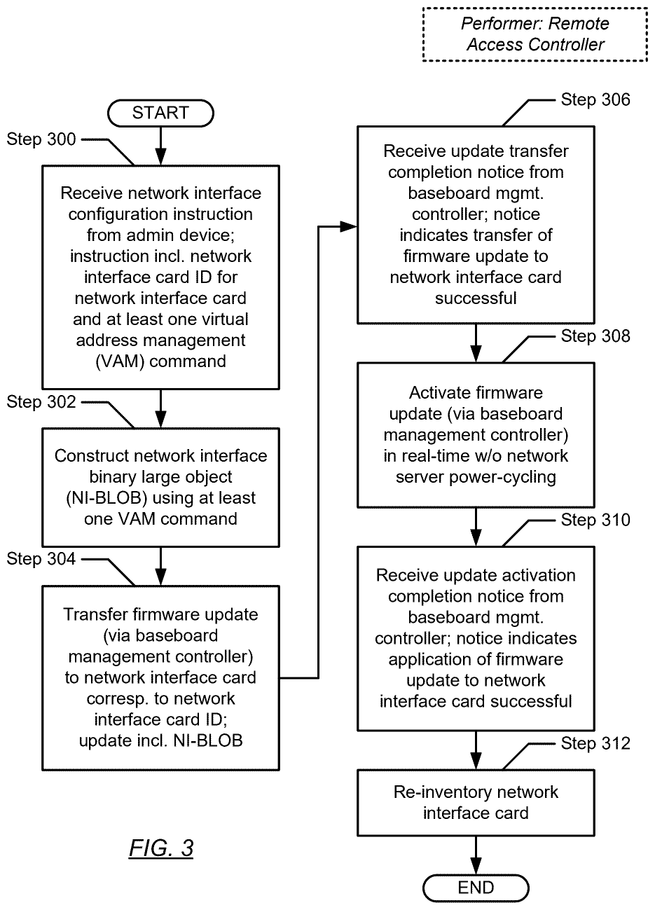

For example, in one or many embodiment(s) described herein, the RAC (108) may include further functionality to perform the real-time, reboot-less configuration of any (enterprise) NIC(s) (104A-104N) as illustrated and described with respect to FIG. 3, below.

In one or many embodiment(s) described herein, the admin device (110) may represent any physical appliance operated by one or more administrators of the network server(s) (102A-102M). Any administrator may refer to an individual or entity whom may be responsible for overseeing network server (102A-102M) operations and maintenance. To that extent, and at least in part, the admin device (110) may enable any administrator(s) to control/configure, monitor, troubleshoot, and/or otherwise interact as needed with the network server(s) (102A-102M) through their respective remote access controller(s) (108). One of ordinary skill, however, will appreciate that the admin device (110) may perform other functionalities without departing from the scope of the embodiments described herein.

Examples of the admin device (110) may include, but are not limited to, a desktop computer, a laptop computer, a smartphone, a tablet computer, or any other computing system similar to the exemplary computing system illustrated and described with respect to FIG. 4, below.

In one or many embodiment(s) described herein, the above-mentioned system (100) components (or subcomponents thereof) may communicate with one another through a network (not shown) (e.g., a local area network (LAN), a wide area network (WAN) such as the Internet, a mobile network, any other network type, or any combination thereof). The network may be implemented using any combination of wired and/or wireless connections. Further, the network may encompass various interconnected, network-enabled subcomponents (or systems) (e.g., switches, routers, gateways, etc.) that may facilitate communications between the above-mentioned system (100) components (or subcomponents thereof). Moreover, in communicating with one another, the above-mentioned system (100) components (or subcomponents thereof) may employ any combination of wired and/or wireless communication protocols.

While FIG. 1 shows a configuration of components and/or subcomponents, other system (100) configurations may be used without departing from the scope of the embodiments described herein.

FIG. 2 shows a network interface binary large object (NI-BLOB) in accordance with one or more embodiments described herein. The NI-BLOB (200) may represent a self-contained (i.e., includes relevant metadata) data unit for storing any amount of binary-formatted, unstructured data specifying a network interface configuration sought to be applied to a network interface card (see e.g., FIG. 1).

To that extent, the NI-BLOB (200) includes a platform level data model (PLDM) firmware update package (202). A PLDM may refer to an interface and data model that provides efficient access to low-level inventory, basic input/output system (BIOS) control, configuration data, as well as monitoring and control functions, concerning a platform (e.g., network server—see e.g., FIG. 1). The PLDM firmware update package (202), in particular, represents a message through which one or more firmware updates may be transferred to one or more devices (e.g., network interface card(s)—see e.g., FIG. 1). Further, the PLDM firmware update package (202) includes a firmware package header (204) and a firmware package payload (206). Each of these PLDM firmware update package (202) components is described below.

In one or many embodiment(s) described herein, the firmware package header (204) may refer to a message section that specifies any device(s) intended to receive a firmware update and the respective firmware update(s) contained in the PLDM firmware update package (202). To that extent, the firmware package header (204) may be broken down into, and thus includes, package header information (208), a firmware device identifier (ID) area (210), a component image information area (212), and a package header checksum (214). Each of these firmware package header (204) subcomponents is described below.

In one or many embodiment(s) described herein, the package header information (208) may refer to a message section structure that specifies details describing the PLDM firmware update package (202). Said details include, but are not limited to: a package header ID uniquely labeling the PLDM firmware update package (202); a package release date encoding a date and time in which the PLDM firmware update package (202) was released; and a package version indicating package version information pertaining to the PLDM firmware update package (202).

In one or many embodiment(s) described herein, the firmware device ID area (210) may refer to a message section structure that specifies details concerning the one or more firmware devices (e.g., network interface card(s)) targeted for firmware update via the PLDM firmware update package (202). Said details include, but are not limited to: a device ID record count indicating a number of firmware device ID records defined within the PLDM firmware update package (202); and a firmware device ID record for each firmware device to be affected by the PLDM firmware update package (202), where the firmware device ID record for a given firmware device may include, but is not limited to: at least one descriptor (e.g., a peripheral component interconnect (PCI) vendor ID assigned to a vendor of the given firmware device, an internet assigned numbers authority (IANA) vendor ID assigned to the vendor of the given firmware device, a plug and play (PnP) vendor ID assigned to the vendor of the given firmware device, an advanced configuration and power interface (ACPI) vendor ID assigned to the vendor of the given firmware device, etc.) applicable to the given firmware device.

In one or many embodiment(s) described herein, the component image information area (212) may refer to a message section structure that specifies details concerning any component image(s) (e.g., firmware update(s)) contained in the PLDM firmware update package (202). Said details include, but are not limited to: a component image count indicating a number of component images contained within the PLDM firmware update package (202); and component image information for each of said component image(s), where the component image information for a given component image may include, but is not limited to: a component classification (216) indicating a component image type (e.g., configuration software, application software, instrumentation, operating system, middleware, etc.) associated with the given component image; a component ID uniquely labeling the given component image; and a component activation methods override (218) indicating a mechanism (e.g., alternating current (AC) power-cycle, direct current (DC) power-cycle, system reboot, self-contained activation upon transmission of a component image activation command, etc.) through which the given component image should activate.

In one or many embodiment(s) described herein, the above-mentioned component classification (216) may be set to reflect a binary value representative of a configuration software option. Said configuration software option indicates that a given component image is classified as configuration software (i.e., firmware update).

In one or many embodiment(s) described herein, the above-mentioned component activation methods override (218) may be set to reflect a binary value representative of a self-contained option. Said self-contained option indicates that a given component image (e.g., firmware update) is to be implemented through self-contained activation. Self-contained activation, in turn, refers to a capability that enables the given component image to immediately (i.e., in real-time) become the actively running component image, on a firmware device (e.g., network interface card), after receiving an appropriate component image activation command. From the perspective of the firmware device, said firmware device may: autonomously initiate an auto-reboot upon receipt of the component image activation command; transition to a bootloader mode; and, subsequently, start up with the configuration change(s) (i.e., firmware update) applied thereto by the activated component image.

In one or many embodiment(s) described herein, the package header checksum (214) may refer to a message section structure that specifies an integrity checksum for a combination of the package header information (208), the firmware device ID area (210), and the component image information area (212), of the firmware package header (204). Said integrity checksum may be generated using any existing checksum function/algorithm.

In one or many embodiment(s) described herein, the firmware package payload (206) may refer to a message section that specifies any firmware update(s) intended to be transferred to any targeted firmware device(s) (e.g., network interface card(s)) via the PLDM firmware update package (202). Any given firmware update may be enacted through, and thus includes, one or more virtual address management (VAM) commands (220)—each of which adjusts a given networking parameter at least in part defining a sought configuration for a targeted firmware device.

Examples of said given networking parameter may include, but are not limited to: a virtual media access control (MAC) address assigned to the targeted firmware device; a virtual internet small computer systems interface (iSCSI) MAC address assigned to the target firmware device; a virtual fibre channel over Ethernet (FCoE) initialization protocol (FIP) MAC address assigned to the target firmware device; an iSCSI initiator internet protocol (IP) address assigned to the target firmware device; an iSCSI initiator subnet mask assigned to the target firmware device; an iSCSI initiator gateway IP address assigned to the target firmware device; an iSCSI initiator name assigned to the target firmware device; an iSCSI target IP address assigned to the target firmware device; an iSCSI target transmission control protocol (TCP) port number assigned to the target firmware device; and an iSCSI target name assigned to the target firmware device.

While FIG. 2 shows a configuration of components and/or subcomponents, other NI-BLOB (200) configurations may be used without departing from the scope of the embodiments described herein.

FIG. 3 shows a flowchart outlining a method for real-time, reboot-less configuration of enterprise network interface cards in accordance with one or more embodiments described herein. The various steps outlined below may be performed by the remote access controller (RAC) (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 3, in Step 300, a network interface configuration instruction is received from the admin device (see e.g., FIG. 1). In one or many embodiment(s) described herein, said network interface configuration instruction may pertain to adjusting a configuration of a network interface card. To said extent, said network interface configuration instruction may include: a network interface card ID uniquely identifying said network interface card; and any number of changes sought to be applied to an existing configuration of said network interface card. Said any number of sought changes, furthermore, may be reflected and/or implemented through one or more virtual address management (VAM) commands (described above—see e.g., FIG. 2).

In Step 302, a network interface binary large object (NI-BLOB) is constructed. In one or many embodiment(s) described herein, the NI-BLOB may be constructed, at least in part, using the VAM command(s) (received via the network interface configuration instruction in Step 300). The constructed NI-BLOB, further, may resemble the exemplary NI-BLOB illustrated and described with respect to FIG. 2, above.

In Step 304, a firmware update is transferred to a network interface card. In one or many embodiment(s) described herein, said transfer may be mediated by/through a baseboard management controller (see e.g., FIG. 1) directly connected to the network interface card. The network interface card, in turn, may be associated with the network interface card ID (received via the network interface configuration instruction in Step 300). Further, the firmware update may include the NI-BLOB (constructed in Step 302).

In Step 306, an update transfer completion notice is received from the baseboard management controller. In one or many embodiment(s) described herein, the update transfer completion notice may refer to a message indicating that the firmware update (transferred in Step 304) has successfully been received by the network interface card.

In Step 308, the firmware update (transferred in Step 304) is activated. In one or many embodiment(s) described herein, activation of the firmware update may entail transmission of an activation command delivered to the network interface card through (or mediated by) the baseboard management controller. Further, through said activation command, the firmware update is implemented in real-time and without any power-cycling of the network server on which the network interface card is installed. Moreover, from the perspective of the network interface card, activation of the firmware update will trigger the network interface card to: autonomously initiate an auto-reboot upon receipt of the activation command; transition to a bootloader mode; and, subsequently, start up with the configuration change(s) applied thereto by the activated firmware update.

In Step 310, an update activation completion notice is received from the baseboard management controller. In one or many embodiment(s) described herein, the update activation completion notice may refer to a message indicating that the firmware update (activated in Step 308) has successfully been applied to the network interface card.

In Step 312, the network interface card is re-inventoried. In one or many embodiment(s) described herein, re-inventorying the network interface card may refer to the refreshment of any network server inventory (e.g., specifying any components thereof) with new details, such as any new information introduced by activation of the firmware update applied to the network interface card.

FIG. 4 shows a computing system in accordance with one or more embodiments described herein. The computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one or many embodiment(s) described herein, the computer processor(s) (402) may be an integrated circuit for processing instructions. For example, the computer processor(s) may be one or more cores or micro-cores of a central processing unit (CPU) and/or a graphics processing unit (GPU). The computing system (400) may also include one or more input devices (410), such as a touchscreen, keyboard, mouse, microphone, touchpad, electronic pen, or any other type of input device. Further, the communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

In one or many embodiment(s) described herein, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments described herein.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for real-time, reboot-less configuration of network interface cards, the method comprising:
constructing a network interface binary large object (NI-BLOB) comprising a firmware update package;
transferring, to a network interface card, a firmware update comprising the NI-BLOB; and
activating, without power-cycling a host whereon the network interface card is installed, the firmware update to configure the network interface card in real-time.

2. The method of claim 1, wherein the firmware update package comprises at least one virtual address management (VAM) command defining an updated configuration for the network interface card.

3. The method of claim 1, wherein the firmware update package is a platform level data model (PLDM) firmware update package.

4. The method of claim 3, wherein the PLDM firmware update package comprises a component image information area comprising a component classification, and wherein the component classification is set to a binary value representative of a configuration software option.

5. The method of claim 4, wherein the component image information area further comprises a component activation methods override, and wherein the component activation methods override is set to a second binary value representative of a self-contained option.

6. The method of claim 2, the method further comprising:
prior to constructing the NI-BLOB:
receiving a network interface configuration instruction comprising the at least one VAM command,
wherein the NI-BLOB is constructed in response to receiving the network interface configuration instruction.

7. The method of claim 6, wherein the network interface configuration instruction further comprises a network interface card identifier (ID) belonging to the network interface card.

8. The method of claim 1, wherein the host is a network server.

9. A non-transitory computer readable medium (CRM) comprising computer readable program code, which when executed by a computer processor, enables the computer processor to perform a method for real-time, reboot-less configuration of network interface cards, the method comprising:
constructing a network interface binary large object (NI-BLOB) comprising a firmware update package;
transferring, to a network interface card, a firmware update comprising the NI-BLOB; and
activating, without power-cycling a host whereon the network interface card is installed, the firmware update to configure the network interface card in real-time.

10. The non-transitory CRM of claim 9, wherein the firmware update package comprises at least one virtual address management (VAM) command defining an updated configuration for the network interface card.

11. The non-transitory CRM of claim 9, wherein the firmware update package is a platform level data model (PLDM) firmware update package.

12. The non-transitory CRM of claim 11, wherein the PLDM firmware update package comprises a component image information area comprising a component classification, and wherein the component classification is set to a binary value representative of a configuration software option.

13. The non-transitory CRM of claim 12, wherein the component image information area further comprises a component activation methods override, and wherein the component activation methods override is set to a second binary value representative of a self-contained option.

14. The non-transitory CRM of claim 10, the method further comprising:
prior to constructing the NI-BLOB:
receiving a network interface configuration instruction comprising the at least one VAM command,
wherein the NI-BLOB is constructed in response to receiving the network interface configuration instruction.

15. The non-transitory CRM of claim 14, wherein the network interface configuration instruction further comprises a network interface card identifier (ID) belonging to the network interface card.

16. The non-transitory CRM of claim 9, wherein the host is a network server.

17. A system, comprising:
a set of network interface cards comprising a network interface card; and
a remote access controller operatively connected to the set of network interface cards, and comprising a computer processor configured to perform a method for real-time, reboot-less configuration of network interface cards, the method comprising:
constructing a network interface binary large object (NI-BLOB) comprising a firmware update package;
transferring, to the network interface card, a firmware update comprising the NI-BLOB; and
activating, without power-cycling a host whereon the network interface card is installed, the firmware update to configure the network interface card in real-time.

18. The system of claim 17, further comprising:
a baseboard management controller disposed between the set of network interface cards and the remote access controller,
wherein the baseboard management controller mediates communications between the set of network interface cards and the remote access controller.

19. The system of claim 18, wherein the host is a network server comprising the set of network interface cards, the baseboard management controller, and the remote access controller.

20. The system of claim 17, further comprising:
an admin device operatively connected to the remote access controller,
wherein the method further comprises:
prior to constructing the NI-BLOB:
receiving, from the admin device, a network interface configuration instruction comprising at least one virtual address management (VAM) command defining an updated configuration for the network interface card,
wherein the NI-BLOB comprises a firmware update package comprising the at least one VAM command.
